(19) United States
(12) Patent Application Publication
(10) Pub. No.: US 2002/0107992 A1
(43) Pub. Date: Aug. 8, 2002

(54) Computer reservation system and method

(76) Inventors: Peter J. Osbourne, Owasso, OK (US); Lawrence F. Zucker, Tusla, OK (US)

Correspondence Address: Eric L. Doyle, Dickinson Wright PLLC, Suite 800, 1901 L. Street, NW, Washington, DC, 20036, US

(21) Appl. No.: 10/037,639

(22) Filed: Nov. 9, 2001

Related U.S. Application Data
(60) Provisional application No. 60/246,738, filed on Nov. 9, 2000.

(51) Int. Cl. G06F 15/163; G06F 9/54; G06F 9/00

(52) U.S. Cl. 709/310

(57) ABSTRACT

A computer reservation system includes a server for receiving commands and transmitting responses in a first format and a client computer system for transmitting request messages and receiving response messages in a second format. A translator receives the request messages in the second format from the client computer system and translates the request messages into the first format. A processor receives the translated request messages from the translator, transforms the translated request messages into commands, transmits the commands to the server, receives responses from the server, processes the responses into processed messages, and transmits the processed messages to the translator. The translator receives the processed messages from the processor, translates the processed messages into the second format, and transmits the response messages in the second format to the client computer system. A method for making a computer reservation includes the steps of: receiving a request message in a first format; translating the request message from the first format to a second format; wrapping the translated message in a SOAP (Simple Object Assess Protocol) packet; parsing the SOAP packet to determine the operation is being called; calling the operation upon a server; creating a SOAP response document from the response from the server; unwrapping the SOAP response document; converting the response from second format to first format; and transmitting a response massage in the first format.

### CROSS-REFERENCES TO RELATED APPLICATIONS

This application claims the benefit of U.S. Provisional Application No. 60/246,738, filed Nov. 9, 2000.

### BACKGROUND OF THE INVENTION

The present invention relates to a computer reservation system and a method of making a computer reservation.

To maximize the capabilities of established information systems, computer systems which process and store this information must be able to communicate and exchange information with each other. Communication and information exchange between two or more computer systems requires compatible message protocols and formats. Frequently, computer systems have message protocols and formats which are incompatible with other computer systems. Accordingly, interfaces have been designed to translate messages between incompatible computer systems. For example, prior art interfaces have taught both socket interfaces and COBRA interfaces. However, these prior art interfaces have several shortcomings. Socket and COBRA interfaces are expensive and require extensive and highly specialized protocol knowledge. Further, such interfaces are relatively inflexible in that an interface designed for a specific computer system often establishes a communication means with only one other predetermined computer system. Accordingly, there is a desire to provide a system and method which overcome the shortcomings of the prior art.

### SUMMARY OF THE INVENTION

The present invention provides a computer reservation system including a server for receiving commands and transmitting responses in a first format and a client computer system for transmitting request messages and receiving response messages in a second format. A translator receives the request messages in the second format from the client computer system and translates the request messages into the first format. A processor receives the translated request messages from the translator, transforms the translated request messages into commands, transmits the commands to the server, receives responses from the server, processes the responses into processed messages, and transmits the processed messages to the translator. The translator receives the processed messages from the processor, translates the processed messages into the second format, and transmits the response messages in the second format to the client computer system.

The present invention also provides a method for making a computer reservation including the steps of: receiving a request message in a first format; translating the request message from the first format to a second format; wrapping the translated message in a SOAP (Simple Object Assess Protocol) packet; parsing the SOAP packet to determine the operation being called; calling the operation on a server; creating a SOAP response document from the response from the server; unwrapping the SOAP response document; converting the response from second format to first format; and transmitting a response massage in the first format.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention will become more fully understood from the detailed description given here below, the appended claims, and the accompanying drawings in which:

FIG. 1 is a schematic of a computer reservation system in accordance with the present invention.

### DETAILED DESCRIPTION OF THE PREFERRED EMBODIMENT

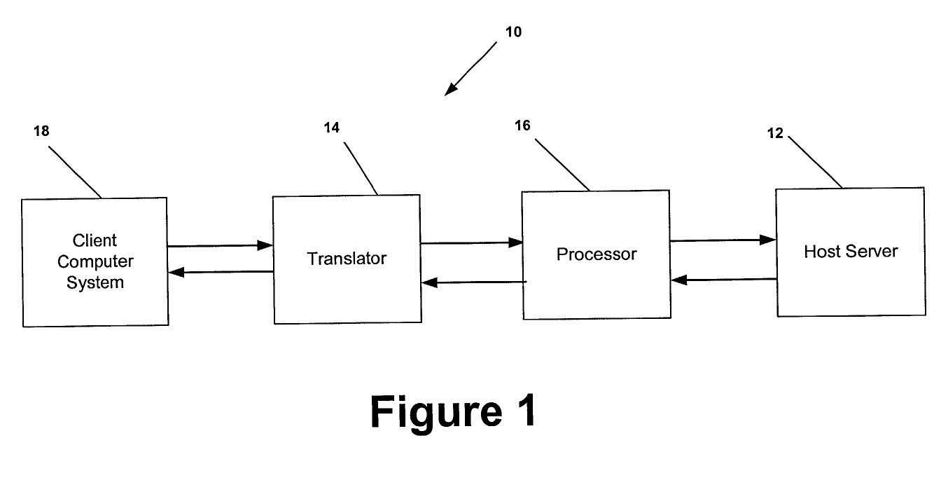

FIG. 1 is a schematic of a computer reservation system 10 in accordance with the present invention. In one aspect of the invention, the computer reservation system 10 includes a host server for processing reservation-related requests 12, a translator 14, and a processor 16. The host server 12 may be, for example, a rental car reservation system containing information for receiving request messages (such as vehicle availability requests, vehicle description requests, rate requests, policy inquiry requests, reservation requests, modification requests and cancellation requests) and providing response messages (such as vehicle availability responses, vehicle description responses, rate responses, policy information responses, reservation confirmations, modification confirmations, and cancellation confirmations). The information stored in the reservation system may include, for example, vehicle types, vehicle availability at one or more locations, rates, rental policies, discounts, and the like.

Upon receiving a reservation-related request message, the system 10 provides a response containing information relevant to the specific request message. The system 10 is capable of responding to several different request messages including vehicle availability requests, vehicle description requests, rate requests, policy inquiry requests, reservation requests, modification requests, and cancellation requests. For example, upon receiving a vehicle availability request message (which includes a selected pick-up location), the system 10 translates the message, processes the translated message, and produces a vehicle availability response including information regarding the types of vehicles available at the selected pick-up location. Upon receiving a vehicle description request message (which includes selected vehicle information), the system 10 translates the message, processes the translated message, and produces a vehicle description response including a description of the selected vehicle. Upon receiving a rate request message (which includes information regarding the pick-up location, vehicle type, as well as pick-up and drop-off dates and times), the system 10 translates the message, processes the translated message, and produces a rate response including rental rate information so that the requestor can decide whether to make a reservation. Upon receiving a rental policy inquiry request message (which includes a selected pick-up location), the system 10 translates the message, processes the translated message, and produces a policy information response including a copy of the rental policy for the selected pick-up location. Upon receiving a reservation request message (which includes information regarding the rate request ID, pick-up location, vehicle type, pick-up and drop-off dates and times, requestor's name, requestor's phone number, and requestor's e-mail address), the system 10 translates the message, processes the translated message, and produces a reservation confirmation response confirming that the reservation has been booked. Upon receiving a modification request message (which includes information regarding the confirmation number, rate request ID, pick-up location, vehicle type, pick-up and drop-off dates and times, requestor's name, requestor's phone number, and requestor's e-mail address), the system 10 translates the message, processes the translated message, and produces a modification confirmation response confirming that the reservation has been modified. Upon receiving a cancellation request message (which includes information regarding the confirmation number, requestor's name, requestor's phone number, and requestor's e-mail address), the system 10 translates the message, processes the translated message, and produces a cancellation confirmation response confirming that the reservation has been cancelled.

The translator 14 receives the request messages from a client computer system 18. Request messages from a variety of client computer systems can have different protocols and formats. Often, the protocol and format of a request message from a specific client computer system is not compatible with the host server 12. Thus, the translator 14 translates request messages into a protocol and format which is compatible with the host server 12. The translator 14 also receives processed messages from the processor 16 and translates the processed messages back into the protocol and format which is compatible with the client computer system 18. In one embodiment of the invention, for example, the translator 14 receives a request message from the client computer system 18, checks the request message to determine the protocol and format, translates the request message from the original format to a server compatible format, and transmits a translated message in the compatible format to the server 12. In one example, the translator 14 receives a request message from an airline computer system, checks the request message to ensure that the request message is in slash format, converts the request message into a SOAP (Simple Object Assess Protocol) packet, and transmits the translated message in a SOAP packet to the processor 16. The translator 14 also receives processed messages or SOAP response documents from the processor 16, unwraps the processed messages, converts the processed messages into slash format, and transmits response messages, in slash format, to the client computer system 18.

The processor 16 processes translated messages into commands that the host server 12 can understand. The processor 16 also processes responses from the host server 12 into processed messages for the translator 14. In one example, the processor 16 receives a translated message in the form of a SOAP packet from the translator 14, parses the packet to determine what reservation-related operation is being called or requested, and calls or commands the requested information from the host server 12. Additionally, the processor 16 receives responses from the host server 12, creates SOAP packets, and transmits the SOAP packets to the translator 14.

Moreover, an embodiment of the present invention may further include two or more client computer systems which transmit request messages to the translator 14.

In accordance with another aspect of the invention, a method for making a computer reservation may include one or more of the following steps: receiving a request message in a first format; translating the request message from the first format into a second format; and processing the translated message in the second format into a command that is compatible with a server. The method may also include one or more of the following steps: receiving the request message in the first format; before translating the request message, determining the format of the request message; processing the translated message; creating a response to the command; processing the response into a message in the second format; and translating the processed message from the second format to the first format.

In one example, the method may include one or more of the following steps: requestor makes request message via sockets using slash format; the translator receives the request message from the client computer system; the translator determines the format of the request message; the translator converts the request message from slash format to XML; translator wraps the translated message in a SOAP packet; the translator sends the SOAP packet to the SOAP processor; the SOAP processor receives the translated message in the SOAP packet from the translator; the SOAP processor parses the SOAP packet to determine what operation is being called or requested; the SOAP processor calls or commands the requested operation on the server; the SOAP processor receives the response from the server; the SOAP processor creates a processed message, or more specifically a SOAP response document; the SOAP processor transmits the SOAP response document to the translator; the translator unwraps the SOAP message; the translator converts the XML data of the processed message into slash format; and the translator transmits the response message, in slash format, to the client.

In accordance with a further aspect of the invention, a combined computer reservation system includes an airline reservation system and a rental car reservation system, wherein the communication between the two systems is conducted using, at least in part, the Simple Object Assess Protocol. The airline reservation system may include a function with which a customer making a reservation with the airline can also reserve a rental car with the rental car company. The information being communicated between the two systems may include (1) a request for rental car information, such as information regarding the requestor, rental period, desired type of vehicle, rental rates, selected locations, and the like, and (2) a response to the request, including information regarding one or more types of vehicles, rates, locations, rental policy, and the like. The communication may also include reservation confirmations, modification requests and cancellation requests.

This application incorporates by reference the entire disclosure and contents of U.S. Provisional Application No. 60/246,738, filed Nov. 9, 2000.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. A computer reservation system comprising:
a server for receiving commands and transmitting responses in a first format;
a client computer system for transmitting request messages and receiving response messages in a second format;
a translator for receiving request messages in the second format from the client computer system and translating request messages into the first format; and
a processor for receiving translated request messages from the translator, transforming the translated request messages into commands, transmitting commands to the server, receiving responses from the server, processing responses into processed messages, and transmitting processed messages to the translator;
the translator receiving processed messages from the processor, translating processed messages into the second format, and transmitting response messages in the second format to the client computer system.

2. The system as set forth in claim 1 further including sockets for communicating request messages between the translator and the client computer system.

3. The system as set forth in claim 1 wherein the client computer system transmits request messages in slash format.

4. The system as set forth in claim 3 wherein the translator translates request messages from slash format to XML format.

5. The system as set forth in claim 4 wherein the translator wraps request messages in SOAP (Simple Object Assess Protocol) packets and transmits the SOAP packets to the processor.

6. The system as set forth in claim 5 wherein the processor wraps processed responses in SOAP packets and transmits the SOAP packets to the translator.

7. The system as set forth in claim 6 wherein the translator translates processed responses from XML format to slash format.

8. A computer reservation system comprising:
a server for receiving commands and transmitting responses in a first format;
a translator for receiving request messages in a second format from a client computer system and translating request messages into the first format; and
a processor for receiving translated request messages from the translator, transforming the translated request messages into commands, transmitting commands to the server, receiving responses from the server, processing responses into processed messages, and transmitting processed messages to the translator; and
the translator receiving processed messages from the processor, translating processed messages into the second format, and transmitting response messages in the second format to the client computer system.

9. The system as set forth in claim 8 further including sockets for communicating request messages between the translator and the client computer system.

10. The system as set forth in claim 8 wherein the translator receives request messages in slash format from the client computer system.

11. The system as set forth in claim 10 wherein the translator translates request messages from slash format to XML format.

12. The system as set forth in claim 11 wherein the translator wraps request messages in SOAP (Simple Object Assess Protocol) packets and transmits the SOAP packets to the processor.

13. The system as set forth in claim 12 wherein the processor wraps processed responses in SOAP packets and transmits the SOAP packets to the translator.

14. The system as set forth in claim 13 wherein the translator translates processed responses from XML format to slash format.

15. A method for making a computer reservation, the steps comprising:
receiving a request message in a first format;
translating the request message from the first format to a second format;
wrapping the translated message in a SOAP (Simple Object Assess Protocol) packet;
parsing the SOAP packet to determine the operation being called;
calling the operation upon a server;
creating a SOAP response document from the response from the server;
unwrapping the SOAP response document;
converting the response from second format to first format; and
transmitting a response massage in the first format.

16. The method of claim 15 further including the step of verifying the format of the request message.

17. The method of claim 15 wherein the step of receiving a request message further includes receiving a request message in slash format; the step of translating the request message further includes translating the request message from slash format to XML format; the step of converting the response further includes converting the response from XML format to slash format; and the step of transmitting a response message further includes transmitting a response message in slash format.
